(19) United States
(12) Patent Application Publication
(10) Pub. No.: US 2017/0032904 A1
(43) Pub. Date: Feb. 2, 2017

(54) SWITCH DEVICE

(71) Applicant: Kabushiki Kaisha Tokai Rika Deniki Seisakusho, Aichi (JP)

(72) Inventor: Takeshi FUJIMOTO, Aichi (JP)

(21) Appl. No.: 15/303,177

(22) PCT Filed: Mar. 31, 2015
(86) PCT No.: PCT/JP2015/060259

§ 371 Date: Oct. 10, 2016

(30) Foreign Application Priority Data
Apr. 16, 2014 (JP) 2014-084613

(51) Int. Cl. H01H 9/18; H01H 25/04

(52) U.S. Cl. CPC H01H 9/18; H01H 25/04

(57) ABSTRACT

Provided is a switch device that enhances the operation feeling of a rod. Two movable contact points (19) that are combined differently depending on whether a rod is operated by tilting upward, downward, leftward, or rightward while in an L position or an R position are moved and operated from an off position to an on position by an upper plate (44) or a lower plate (45).

### TECHNICAL FIELD

The present invention relates to a switch device provided with an operation member on which a tilt operation is performed in a plurality of directions.

### BACKGROUND ART

For example, a switch device provided with an operation member that is used by a driver of a vehicle to operate a left-side door mirror and a right-side door mirror is known. A rotation operation to two effective rotation positions around an axis is performed on the operation member, and a tilt operation is performed in the up direction, the down direction, the left direction, and the right direction, in each of the two rotation positions. The two rotation positions are for selecting one of the left-side door mirror and the right-side door mirror. When the tilt operation is performed on the operation member in one of the rotation positions, one of the door mirrors tilts in an orientation corresponding to the tilt direction of the operation member. When the tilt operation is performed on the operation member in the other of the rotation positions, the other door mirror tilts in an orientation corresponding to the tilt direction of the operation member.

### CITATION LIST

### Patent Document

Patent Document 1: Japanese Unexamined Patent Application Publication (translation of PCT application) No. 2002-508582A

Patent Document 2: Japanese Unexamined Patent Application Publication No. 2004-71416A

Patent Document 3: Japanese Unexamined Patent Application Publication No. H10-302578A

### SUMMARY OF INVENTION

### Technical Problem

In the case of the above-described switch device, a sliding contact is caused to slide with respect to a pair of fixed contacts in response to the rotation operation or the tilt operation on the operation member, and, as a result of the pair of fixed contacts being electrically connected via the sliding contact, the door mirror corresponding to the rotation position of the operation member is caused to tilt in the orientation corresponding to the tilt direction of the operation member. There has therefore been a tendency for the operational feeling of the operation member to deteriorate as a result of sliding resistance of the sliding contact.

### Solution to Problem

According to an aspect of the present invention, provided is a switch device including: an operation member configured to be rotationally operated to a plurality of effective rotation positions around an axis, a tilt operation being performed on the operation member in a plurality of directions that are common to each of the plurality of rotation positions; a plurality of switch operation parts provided on the operation member, the switch operation parts being displaced from each other in a circumferential direction around the axis of the operation member; a plurality of opposite contacts each capable of moving between an off position and an on position; and a plurality of fixed contacts provided for each of the plurality of opposite contacts, the fixed contacts facing the respective opposite contacts via a gap when the opposite contacts are in the off position and being in contact with the respective opposite contacts when the opposite contacts are in the on position. In such a switch device, the plurality of opposite contacts are arranged such that at least two of the opposite contacts, combinations of which differ depending on in which of the plurality of directions the tilt operation is performed on the operation member in which of the plurality of rotation positions, are operated to move from the off position to the on position by one of the plurality of switch operation parts.

According to another aspect of the present invention, with respect to the above-described aspect [1], the device may further include a light source arranged facing one end surface in an axial direction of the operation member and configured to emit light toward the one end surface of the operation member. The operation member has translucency so as to allow the light emitted from the light source to exit from the other end surface of the operation member in the axial direction.

According to another aspect of the present invention, with respect to the above-described aspects [1] and [2], the device may further include: a body housing the plurality of opposite contacts and the plurality of fixed contacts; a rotation member rotatably housed inside the body, the rotation member being coupled to the operation member such that the operation member is capable of tilting and such that the operation member is capable of rotating integrally with the rotation member; and a support member housed inside the body, the support member being incapable of moving with respect to a movement direction of the plurality of opposite contacts from the off position to the on position. The support member supports the rotation member in a direction opposite to the movement direction of the plurality of opposite contacts from the off position to the on position.

### Advantageous Effects of Invention

According to the switch device of the above-described aspect [1], the at least two opposite contacts, the combinations of which differ depending on in which of the plurality of directions the tilt operation is performed on the operation member in which of the plurality of rotation positions, are operated to move from the off position to the on position by one of the plurality of switch operation parts. As a result, a sliding contact is not necessary, and the operational feeling of the operation member is improved.

According to the switch device of the above-described aspect [2], the light emitted from the light source exits through both the one end surface in the axial direction of the operation member and the other end surface. As a result, the operation member is efficiently illuminated by the light emitted from the light source.

According to the switch device of the above-described aspect [3], when the tilt operation is performed on the operation member, the support member prevents the movement of the rotation member in the movement direction of the opposite contacts from the off position to the on position, the movement being caused by an operation force with respect to the operation member. As a result, the operation member is prevented from moving together with the rotation member in the movement direction, and thus the opposite contacts that do not correspond to the tilt direction of the operation member are prevented from being mistakenly operated to move from the off position to the on position by the switch operation parts of the operation member.

### BRIEF DESCRIPTION OF DRAWINGS

FIG. 1 illustrates an explanatory diagram of a power supply path for a motor of an outer mirror device according to a first embodiment.

FIG. 2 is a cross-sectional view illustrating an internal configuration of a switch device.

FIG. 3A is an explanatory diagram illustrating an arrangement of opposite contacts.

FIG. 3B is an explanatory diagram illustrating an arrangement of the opposite contacts.

FIG. 3C is an explanatory diagram illustrating an arrangement of the opposite contacts.

### DESCRIPTION OF EMBODIMENT

### First Embodiment

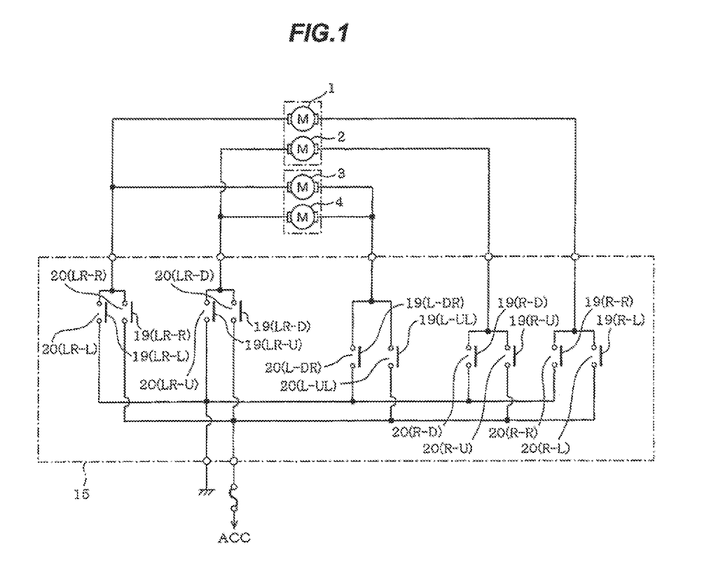

An outer mirror device, which is a switch device illustrated in FIG. 1, is installed in a vehicle, and has a right LR motor 1, a right UD motor 2, a left LR motor 3, a left UD motor 4, a right door mirror, and a left door mirror. The right door mirror is a mirror mounted on a surface of a front door on the right side, as seen by a driver. This right door mirror can rotate in the left and right directions around an axis oriented in the up and down directions and can rotate in the up and down directions around an axis oriented in the left and right directions. In response to the forward rotation of the right LR motor 1, the right door mirror is caused to tilt in one of the left direction and the right direction, and is caused to tilt in the other direction in response to the reverse rotation. In response to the forward rotation of the right UD motor 2, the right door mirror is caused to tilt in one of the up direction and the down direction, and is caused to tilt in the other direction in response to the reverse rotation.

The left door mirror is a mirror mounted on a surface of a front door on the left side, as seen by the driver. This left door mirror can rotate in the left and right directions around the axis oriented in the up and down directions and can rotate in the up and down directions around the axis oriented in the left and right directions. In response to the forward rotation of the left LR motor 3, the left door mirror is caused to tilt in one of the left direction and the right direction, and is caused to tilt in the other direction in response to the reverse rotation. In response to the forward rotation of the left UD motor 4, the left door mirror is caused to tilt in one of the up direction and the down direction, and is caused to tilt in the other direction in response to the reverse rotation.

The switch device is a device for supplying a driving power for the forward rotation and a driving power for the reverse rotation to each of the four motors, namely, the right LR motor 1 to the left UD motor 4, of the outer mirror device. This switch device is mounted so as to be positioned inside the vehicle when the front door on the driver side of the vehicle is in a closed state, and is configured as described below.

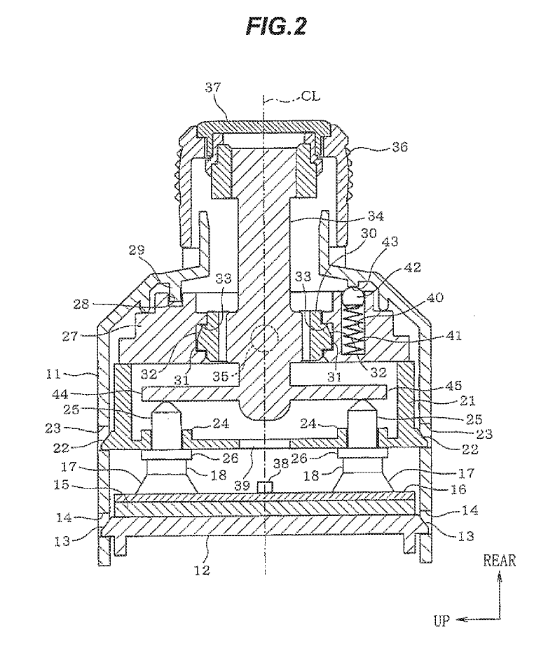

A body 11 in FIG. 2 is formed of a synthetic resin, and a flat plate-shaped insulator 12 is housed inside the body 11. A plurality of pawl portions 13 are integrally formed on the insulator 12, and each of the plurality of pawl portions 13 is engaged inside an engaging hole 14. The plurality of engaging holes 14 are formed in the body 11, and the insulator 12 is immovably fixed inside the body 11 by the plurality of pawl portions 13 engaging inside the engaging holes 14.

As illustrated in FIG. 2, a fixing board 15 is fixed to the rear surface of the insulator 12. The fixing board 15 is formed of a printed wiring board, and a rubber contact rubber 16 is fixed to the rear surface of the fixing board 15. The contact rubber 16 has a flat-plate shape that covers the rear surface of the fixing board 15 in a watertight manner, and ten skirts 17 are integrally formed on the contact rubber 16. In a natural state, each of these ten skirts 17 has a cylindrical shape whose diameter dimension becomes smaller from the front toward the rear. When an external force acts on the skirt 17 from the rear toward the front, the skirt 17 elastically deforms from the natural state to a pressed state, and when the external force disappears, the skirt 17 returns to the natural state from the pressed state as a result of an elastic restoring force.

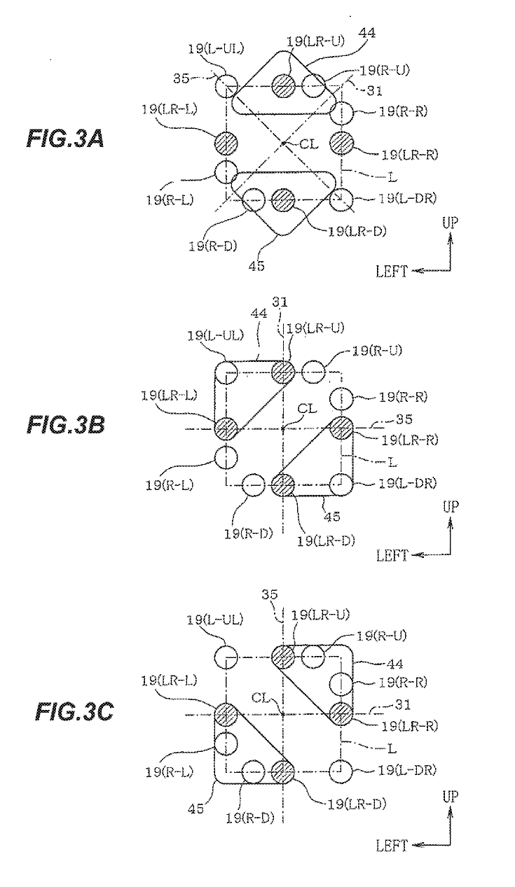

As illustrated in FIG. 2, a circular column-shaped holder 18 is integrally formed with each of the ten skirts 17 of the contact rubber 16. These ten holders 18 are arranged on a square virtual line L (refer to FIGS. 3A to 3C), and move in the front-rear direction in accordance with the deformation of the skirts 17 between the natural state and the pressed state.

In FIGS. 3A to 3C, ten moving contacts, namely, an L-UL moving contact 19, an LR-U moving contact 19, an R-U moving contact 19, an R-R moving contact 19, an LR-R moving contact 19, an L-DR moving contact 19, an LR-D moving contact 19, an R-D moving contact 19, an R-L moving contact 19, and an LR-L moving contact 19 are positioned inside the skirts 17 on the front surfaces of the mutually differing holders 18. Each of these ten moving contacts 19 is at rest in an off position when the skirt 17 is in the natural state, and moves to an on position, which is more to the front than the off position, when the skirt 17 is in the pressed state. Each of these ten moving contacts 19 corresponds to an opposite contact, and is arranged on the virtual line L.

As illustrated in FIG. 1, a power supply pattern is formed on the rear surface of the fixing board 15. This power supply pattern is used to supply the driving power for the forward rotation and the driving power for the reverse rotation to each of the right LR motor 1 to the left UD motor 4 of the outer mirror device. The power supply pattern includes ten pairs of fixed contacts, namely, a pair of LR-L fixed contacts 20, a pair of LR-R fixed contacts 20, a pair of LR-U fixed contacts 20, a pair of LR-D fixed contacts 20, a pair of L-DR fixed contacts 20, a pair of L-UL fixed contacts 20, a pair of R-D fixed contacts 20, a pair of R-U fixed contacts 20, a pair of R-R fixed contacts 20, and a pair of R-L fixed contacts 20.

The pair of LR-L fixed contacts 20 face the LR-L moving contact 19 from the front, via a gap, when the LR-L moving contact 19 is in the off position, and when the LR-L moving contact 19 is in the on position, the pair of LR-L fixed contacts 20 are electrically connected via the LR-L moving contact 19, in response to the LR-L moving contact 19 coming into contact with the pair of LR-L fixed contacts 20 from the rear. The pair of LR-R fixed contacts 20 face the LR-R moving contact 19 from the front, via a gap, when the LR-R moving contact 19 is in the off position, and when the LR-R moving contact 19 is in the on position, the pair of LR-R fixed contacts 20 are electrically connected via the LR-R moving contact 19, in response to the LR-R moving contact 19 coming into contact with the pair of LR-R fixed contacts 20 from the rear.

The pair of LR-U fixed contacts 20 face the LR-U moving contact 19 from the front, via a gap, when the LR-U moving contact 19 is in the off position, and when the LR-U moving contact 19 is in the on position, the pair of LR-U fixed contacts 20 are electrically connected via the LR-U moving contact 19, in response to the LR-U moving contact 19 coming into contact with the pair of LR-U fixed contacts 20 from the rear. The pair of LR-D fixed contacts 20 face the LR-D moving contact 19 from the front, via a gap, when the LR-D moving contact 19 is in the off position, and when the LR-D moving contact 19 is in the on position, the pair of LR-D fixed contacts 20 are electrically connected via the LR-D moving contact 19, in response to the LR-D moving contact 19 coming into contact with the pair of LR-D fixed contacts 20 from the rear.

The pair of L-DR fixed contacts 20 face the L-DR moving contact 19 from the front, via a gap, when the L-DR moving contact 19 is in the off position, and when the L-DR moving contact 19 is in the on position, the pair of L-DR fixed contacts 20 are electrically connected via the L-DR moving contact 19, in response to the L-DR moving contact 19 coming into contact with the pair of L-DR fixed contacts 20 from the rear. The pair of L-UL fixed contacts 20 face the L-UL moving contact 19 from the front, via a gap, when the

L-UL moving contact 19 is in the off position, and when the L-UL moving contact 19 is in the on position, the pair of L-UL fixed contacts 20 are electrically connected via the L-UL moving contact 19, in response to the L-UL moving contact 19 coming into contact with the pair of L-UL fixed contacts 20 from the rear.

The pair of R-D fixed contacts 20 face the R-D moving contact 19 from the front, via a gap, when the R-D moving contact 19 is in the off position, and when the R-D moving contact 19 is in the on position, the pair of R-D fixed contacts 20 are electrically connected via the R-D moving contact 19, in response to the R-D moving contact 19 coming into contact with the pair of R-D fixed contacts 20 from the rear. The pair of R-U fixed contacts 20 face the R-U moving contact 19 from the front, via a gap, when the R-U moving contact 19 is in the off position, and when the R-U moving contact 19 is in the on position, the pair of R-U fixed contacts 20 are electrically connected via the R-U moving contact 19, in response to the R-U moving contact 19 coming into contact with the pair of R-U fixed contacts 20 from the rear.

The pair of R-R fixed contacts 20 face the R-R moving contact 19 from the front, via a gap, when the R-R moving contact 19 is in the off position, and when the R-R moving contact 19 is in the on position, the pair of R-R fixed contacts 20 are electrically connected via the R-R moving contact 19, in response to the R-R moving contact 19 coming into contact with the pair of R-R fixed contacts 20 from the rear. The pair of R-L fixed contacts 20 face the R-L moving contact 19 from the front, via a gap, when the R-L moving contact 19 is in the off position, and when the R-L moving contact 19 is in the on position, the pair of R-L fixed contacts 20 are electrically connected via the R-L moving contact 19, in response to the R-L moving contact 19 coming into contact with the pair of R-L fixed contacts 20 from the rear.

As illustrated in FIG. 2, a synthetic resin inner body 21 is housed inside the body 11. This inner body 21 is disposed to the rear of the ten holders 18, and a plurality of pawl portions 22 are integrally formed on the inner body 21. Each of the plurality of pawl portions 22 is engaged inside an engaging hole 23. The plurality of engaging holes 23 are formed in the body 11, and the inner body 21 is immovably fixed inside the body 11 by the plurality of pawl portions 22 engaging inside the engaging holes 23. The inner body 21 corresponds to a support member.

As illustrated in FIG. 2, ten guide cylinder portions 24 are integrally formed in the inner body 21. Each of these ten guide cylinder portions 24 have a cylindrical shape whose front surface and rear surface are open, and a column-shaped pusher 25 is inserted inside each of the ten guide cylinder portions 24. Each of these ten pushers 25 can move in the front-rear direction along the inner surface of the guide cylinder portion 24, and a head 26 is formed on the front end portion of each of the ten pushers 25. Each of these ten heads 26 has a circular-plate shape whose diameter dimension is greater than that of the holder 18, and is in contact with the mutually differing holders 18 from the rear.

As illustrated in FIG. 2, a rotor 27 is housed inside the body 11. This rotor 27 has a cylindrical shape that extends in the front-rear direction, and a concave guide groove 28 is formed in the rotor 27. This guide groove 28 has a circular shape whose center is an axial centerline CL of the rotor 27, and a guide protrusion 29 is inserted into the guide groove 28. This guide protrusion 29 is integrally formed with the body 11. This guide protrusion 29 has a cylindrical shape whose center is the axial centerline CL of the rotor 27, and the rotor 27 can rotate with respect to the body 11 and the inner body 21 around the axial centerline CL as a result of the inner surface of the guide groove portion 28 being guided by the guide protrusion 29. This rotor 27 corresponds to a rotation member.

As illustrated in FIG. 2, a synthetic resin inner rotor 30 is housed inside the rotor 27. This inner rotor 30 has a cylindrical shape and is coaxial with the rotor 27, and two shaft portions 31 are integrally formed with the inner rotor 30. These two shaft portions 31 each protrude in the radial direction from the outer peripheral surface of the inner rotor 30, and are arranged opposite to each other in the radial direction on both sides of the axial centerline CL. Each of these two shaft portions 31 has a circular-column shape, and an inclined surface 32 is formed in a position on a rear half portion of each of the two shaft portions 31.

As illustrated in FIG. 2, two shaft bearings 33 are formed on the inner peripheral surface of the rotor 27. Each of these two shaft bearings 33 has a concave shape whose inner peripheral surface is set in a circular shape, and the shaft portion 31 of the inner rotor 30 is inserted into each of the two shaft bearings 33. This inner rotor 30 is inserted into the rotor 27 by pushing in the inclined surfaces 32 of the two shaft portions 31 from the front toward the rear. This inner rotor 30 can rotate with respect to the rotor 27 around the two shaft portions 31, and can rotate integrally with the rotor 27 around the axial centerline CL.

As illustrated in FIG. 2, a rod 34 is inserted into the inner rotor 30. This rod 34 is formed of a transparent synthetic resin having translucency. This rod 34 has a circular-column shape and is coaxial with the rotor 27 and the inner rotor 30, and two shaft portions 35 are integrally formed with the rod 34. Each of these two shaft portions 35 has a circular-column shape and protrudes in the radial direction from the outer peripheral surface of the rod 34, and is orthogonal to the two shaft portions 31 of the inner rotor 30. This rod 34 corresponds to an operation member.

As illustrated in FIG. 2, each of the two shaft portions 35 of the rod 34 is inserted into the inner rotor 30. This rod 34 capable of tilting with respect to the rotor 27 and the inner rotor 30 around the two shaft portions 35 can tilt integrally with the inner rotor 30 around the two shaft portions 31 with respect to the rotor 27, and can rotate integrally with the rotor 27 and the inner rotor 30 around the axial centerline CL. This axial centerline CL corresponds to an axis of the operation member.

As illustrated in FIG. 2, a knob operation part 36 is fixed to the rear end portion of the rod 34. This knob operation part 36 is gripped by the fingers of the driver in order to operate the rod 34, and a window plate 37 is fixed to the knob operation part 36. This window plate 37 covers the rear surface of the knob operation part 36, and is formed of a transparent synthetic resin having translucency.

As illustrated in FIG. 2, a light-emitting diode (LED) 38 is installed on the fixing board 15. This LED 38 arranged on the axial centerline CL is of a top view type and emits light from the front to the rear along the axial centerline CL. This LED 38 is switched on when the headlights of the vehicle are on, and is arranged facing the front end surface of the rod 34 via a through-hole 39. This through-hole 39 is formed in the inner body 21. The light emitted from the LED 38 enters, via the through-hole 39, into the rod 34 through the front end surface of the rod 34, and exits from the rear end surface of the rod 34 through the window plate 37. Specifically, the LED 38 illuminates the rod 34 and the window plate 37, and corresponds to a light source.

As illustrated in FIG. 2, a spring housing portion 40 is formed on the rotor 27. This spring housing portion 40 has a concave shape whose rear surface is open, and a detent spring 41 is housed inside the spring housing portion 40. This detent spring 41 is formed of a compression coil spring, and a detent ball 42 is fixed to the rear end portion of the detent spring 41.

As illustrated in FIG. 2, a left concave portion 43 is formed in the guide protrusion 29 of the body 11. This left concave portion 43 has a concave shape into which the detent ball 42 can be engaged, from the front, by a spring force of the detent spring 41. By the detent ball 42 being engaged in the left concave portion 43, the rod 34 stops in an L position in the rotating direction around the axial centerline CL.

A center concave portion and a right concave portion are formed in the guide protrusion 29 of the body 11. Each of the center concave portion and right concave portion has a concave shape into which the detent ball 42 can be engaged, from the front, by the spring force of the detent spring 41. By the detent ball 42 being engaged in the center concave portion, the rod 34 stops in an N position, and by the detent ball 42 being engaged in the right concave portion, the rod 34 stops in an R position. As seen by the driver, the center concave portion is formed in a position displaced by 45 degrees in the clockwise direction from the left concave portion 43, and the N position is set in a position displaced by 45 degrees in the clockwise direction from the L position. As seen by the driver, the right concave portion is formed in a position displaced by 45 degrees in the clockwise direction from the center concave portion, and the R position is set in a position displaced by 45 degrees in the clockwise direction from the N position. Each of the L position and the R position corresponds to an effective rotation position.

As illustrated in FIG. 2, an upper plate 44 and a lower plate 45 are integrally formed with the rod 34. As illustrated in FIGS. 3A to 3C, each of the upper plate 44 and the lower plate 45 is a plate having an equilateral triangle shape, and are set to have a relationship of point symmetry centering on the axial centerline CL. The upper plate 44 and the lower plate 45 are displaced from each other in the circumferential direction, and correspond to a switch operation part.

As illustrated in FIG. 2, irrespective of whether the rod 34 is stopped in the N position, the L position, or the R position, each of the upper plate 44 and the lower plate 45 comes into contact, from the rear, with the plurality of pushers 25. In a state in which an operation force is not acting on the rod 34 in each of the N position to the R position, the upper plate 44 and the lower plate 45 stop in a vertical neutral posture due to the elastic force of the plurality of skirts 17, and the rod 34 stops in an upright posture extending straight in the front-rear direction, via the upper plate 44 and the lower plate 45.

When the tilt operation in each of the up, down, left, and right directions is performed on the rod 34 that is in the upright posture in one of the L position and the R position of the rod 34, the upper plate 44 and the lower plate 45 are tilted with respect to the neutral posture to be in a tilted posture. The tilted posture of the upper plate 44 and the lower plate 45 pushes two of the ten pushers 25 from the rear toward the front. When the two pushers 25 are pushed, two of the skirts 17 elastically deform from the natural state to the pressed state and two of the moving contacts 19 move from the off position to the on position. When the two moving contacts 19 move from the off position to the on position, two sets of the fixed contacts 20 are electrically connected.

When the operation force on the rod 34 disappears in a state in which the tilt operation has been performed on the rod 34, the two skirts 17 elastically return from the pressed state to the natural state, and the two moving contacts 19 return from the on position to the off position. When the two moving contacts 19 return to the off position, the two sets of fixed contacts 20 are electrically disconnected. When the two moving contacts 19 return to the off position, the two pushers 25 are operated to move from the front toward the rear via the holders 18, and thus push the upper plate 44 and the lower plate 45 in the same direction. By being pushed in the same direction, the upper plate 44 and the lower plate 45 return from the tilted posture to the neutral posture, and the rod 34 returns to the upright posture as a result of the upper plate 44 and the lower plate 45 returning to the neutral posture.

### <Tilt Operation on Rod 34 in N Position>

FIG. 3A illustrates positional relationships of the upper plate 44 and the lower plate 45 with respect to the ten moving contacts 19 when the rod 34 is in the N position. The upper plate 44 faces the LR-U moving contact 19, the R-U moving contact 19, and the R-R moving contact 19 from the rear via the pushers 25 and the holders 18, and the lower plate 45 faces the RL moving contact 19, the R-D moving contact 19, and the LR-D moving contact 19 from the rear via the pushers 25 and the holders 18. When the rod 34 is in the N position, the two shaft portions 31 of the inner rotor 30 are tilted 45 degrees with respect to the up and down directions, and the two shaft portions 35 of the rod 34 are tilted 45 degrees with respect to the left and right directions, which prohibits the tilt operation on the rod 34 in all the up, down, left, and right directions.

### <Tilt Operation on Rod 34 in L Position>

FIG. 3B illustrates positional relationships of the upper plate 44 and the lower plate 45 with respect to the ten moving contacts 19 when the rod 34 is in the L position. The upper plate 44 faces the LR-L moving contact 19, the L-UL moving contact 19, and the LR-U moving contact 19 from the rear via the pushers 25 and the holders 18, and the lower plate 45 faces the LR-D moving contact 19, the L-DR moving contact 19, and the LR-R moving contact 19 from the rear via the pushers 25 and the holders 18. When the rod 34 is in the L position, the two shaft portions 31 of the inner rotor 30 are oriented in the up and down directions, and the two shaft portions 35 of the rod 34 are oriented in the left and right directions, which allows for the tilt operation on the rod 34 in either the up, down, left, or right direction.

As illustrated in FIG. 3B, when the tilt operation is performed on the tilt the rod 34 in the up direction when the rod 34 is in the L position, the upper plate 44 enters the tilted posture from the neutral posture, and thus the L-UL moving contact 19 and the LR-U moving contact 19 are operated to move from the off position to the on position. When the L-UL moving contact 19 and the LR-U moving contact 19 are in the on position, the L-UL fixed contacts 20 and the LR-U fixed contacts 20 in FIG. 1 are electrically connected, and thus the driving power for one of the forward rotation and the reverse rotation is supplied to the left UD motor 4, and the left door mirror tilts in the upward orientation.

As illustrated in FIG. 3B, when the tilt operation is performed on the rod 34 in the down direction when the rod 34 is in the L position, the lower plate 45 enters the tilted posture from the neutral posture, and thus the LR-D moving contact 19 and the L-DR moving contact 19 are operated to move from the off position to the on position. When the LR-D moving contact 19 and the L-DR moving contact 19 are in the on position, the LR-D fixed contacts 20 and the L-DR fixed contacts 20 in FIG. 1 are electrically connected, and thus the driving power for the other of the forward rotation and the reverse rotation is supplied to the left UD motor 4, and the left door mirror tilts in the downward orientation.

As illustrated in FIG. 3B, when the tilt operation is performed on the rod 34 in the left direction when the rod 34 is in the L position, the upper plate 44 enters the tilted posture from the neutral posture, and thus the L-UL moving contact 19 and the LR-L moving contact 19 are operated to move from the off position to the on position. When the L-UL moving contact 19 and the LR-L moving contact 19 are in the on position, the L-UL fixed contacts 20 and the LR-L fixed contacts 20 in FIG. 1 are electrically connected, and thus the driving power for one of the forward rotation and the reverse rotation is supplied to the left LR motor 3, and the left door mirror tilts in the leftward orientation.

As illustrated in FIG. 3B, when the tilt operation is performed on the rod 34 in the right direction when the rod 34 is in the L position, the lower plate 45 enters the tilted posture from the neutral posture, and thus the LR-R moving contact 19 and the L-DR moving contact 19 are operated to move from the off position to the on position. When the LR-R moving contact 19 and the L-DR moving contact 19 are in the on position, the LR-R fixed contacts 20 and the L-DR fixed contacts 20 in FIG. 1 are electrically connected, and thus the driving power for the other of the forward rotation and the reverse rotation is supplied to the left LR motor 3, and the left door mirror tilts in the rightward orientation.

The LR-U moving contact 19, the LR-R moving contact 19, the LR-D moving contact 19, and the LR-L moving contact 19 (see oblique lines in FIGS. 3A to 3C) are supported by the skirts 17 for which the elastic force is set to the same high value, while the L-UL moving contact 19, the R-U moving contact 19, the R-R moving contact 19, the L-DR moving contact 19, the R-D moving contact 19, and the R-L moving contact 19 (see white circles in FIGS. 3A to 3C) are supported by the skirts 17 for which the elastic force is set to the same low value. When the tilt operation is performed on the rod 34 in the L position in either the up, down, left, or right direction, two of the skirts 17, namely, one of the two skirts 17 having a higher elastic force and the other of the two skirts 17 having a lower elastic force, enter the pressed state from the natural state. As a result, the same detent feeling is imparted to the tilt operation in each of the up, down, left, and right directions of the rod 34 in the L position.

As illustrated in FIG. 3B, the ten moving contacts 19 are arranged on the square virtual line L, and the operation stroke of the rod 34 required for the upper plate 44 to operate the L-UL moving contact 19 and the LR-U moving contact 19 from the off position to the on position, the operation stroke of the rod 34 required for the lower plate 45 to operate the LR-D moving contact 19 and the L-DR moving contact 19 from the off position to the on position, the operation stroke of the rod 34 required for the upper plate 44 to operate the

LR-L moving contact 19 and the L-UL moving contact 19 from the off position to the on position, and the operation stroke of the rod 34 required for the lower plate 45 to operate the LR-R moving contact 19 and the L-DR moving contact 19 from the off position to the on position are set to the same value (ST). Thus, a period of time from when the driver starts the tilt operation on the rod 34 in the L position to when the driver feels the detent feeling is made constant in each of the up, down, left, and right directions. As a result, the same operational feeling is imparted to the tilt operation on the rod 34 in the L position.

### <Tilt Operation on Rod 34 in R Position>

FIG. 3C illustrates positional relationships of the upper plate 44 and the lower plate 45 with respect to the ten moving contacts 19 when the rod 34 is in the R position. The upper plate 44 faces the LR-U moving contact 19, the R-U moving contact 19, the R-R moving contact 19, and the LR-R moving contact 19 from the rear via the pushers 25 and the holders 18, and the lower plate 45 faces the LR-L moving contact 19, the R-L moving contact 19, the R-D moving contact 19, and the LR-D moving contact 19 from the rear via the pushers 25 and the holders 18. When the rod 34 is in the position R, the two shaft portions 31 of the inner rotor 30 are oriented in the left and right directions, and the two shaft portions 35 of the rod 34 are oriented in the up and down directions, which allows for the tilt operation on the rod 34 in either the up, down, left, or right direction.

As illustrated in FIG. 3C, when the tilt operation is performed on the rod 34 in the up direction when the rod 34 is in the R position, the upper plate 44 enters the tilted posture from the neutral posture, and thus the LR-U moving contact 19 and the R-U moving contact 19 are operated to move from the off position to the on position. When the LR-U moving contact 19 and the R-U moving contact 19 are in the on position, the LR-U fixed contacts 20 and the R-U fixed contacts 20 in FIG. 1 are electrically connected, and thus the driving power for one of the forward rotation and the reverse rotation is supplied to the right UD motor 2, and the right door mirror tilts in the upward orientation.

As illustrated in FIG. 3C, when the tilt operation is performed on the rod 34 in the down direction when the rod 34 is in the R position, the lower plate 45 enters the tilted posture from the neutral posture, and thus the LR-D moving contact 19 and the R-D moving contact 19 are operated to move from the off position to the on position. When the LR-D moving contact 19 and the R-D moving contact 19 are in the on position, the LR-D fixed contacts 20 and the R-D fixed contacts 20 in FIG. 1 are electrically connected, and thus the driving power for the other of the forward rotation and the reverse rotation is supplied to the right UD motor 2, and the right door mirror tilts in the downward orientation.

As illustrated in FIG. 3C, when the tilt operation is performed on the rod 34 in the left direction when the rod 34 is in the R position, the lower plate 45 enters the tilted posture from the neutral posture, and thus the LR-L moving contact 19 and the R-L moving contact 19 are operated to move from the off position to the on position. When the LR-L moving contact 19 and the R-L moving contact 19 are in the on position, the LR-L fixed contacts 20 and the R-L fixed contacts 20 in FIG. 1 are electrically connected, and thus the driving power for one of the forward rotation and the reverse rotation is supplied to the right LR motor 1, and the right door mirror tilts in the leftward orientation.

As illustrated in FIG. 3C, when the tilt operation is performed on the rod 34 in the right direction when the rod 34 is in the R position, the upper plate 44 enters the tilted posture from the neutral posture, and thus the R-R moving contact 19 and the LR-R moving contact 19 are operated to move from the off position to the on position. When the R-R moving contact 19 and the LR-R moving contact 19 are in the on position, the R-R fixed contacts 20 and the LR-R fixed contacts 20 in FIG. 1 are electrically connected, and thus the driving power for the other of the forward rotation and the reverse rotation is supplied to the right LR motor 1, and the right door mirror tilts in the rightward orientation. Specifically, two of the moving contacts 19, combinations of which differ depending on in which of the up, down, left, and right directions the tilt operation is performed on the rod 34 when the rod 34 is in either the L position or the R position, are operated to move from the off position to the on position by the upper plate 44 or the lower plate 45.

As illustrated in FIG. 3C, when the tilt operation is performed on the rod 34, which is in the R position, in each of the up, down, left, and right directions, two of the skirts 17, namely, one of the two skirts 17 having a higher elastic force and the other of the two skirts 17 having a lower elastic force are caused to enter the pressed state from the natural state. As a result, the same detent feeling is imparted to the tilt operation in each of the up, down, left, and right directions of the rod 34 in the R position as at the time of the tilt operation in the L position.

The operation stroke of the rod 34 required for the upper plate 44 to operate the LR-U moving contact 19 and the R-U moving contact 19 from the off position to the on position, the operation stroke of the rod 34 required for the lower plate 45 to operate the LR-D moving contact 19 and the R-D moving contact 19 from the off position to the on position, the operation stroke of the rod 34 required for the lower plate 45 to operate the LR-L moving contact 19 and the R-L moving contact 19 from the off position to the on position, and the operation stroke of the rod 34 required for the upper plate 44 to operate the LR-R moving contact 19 and the R-R moving contact 19 from the off position to the on position are set to the same value (ST) as the operation stroke of the rod 34 in the L position. Thus, a period of time from when the driver starts the tilt operation on the rod 34 in the R position to when the driver feels the detent feeling is made constant in each of the up, down, left, and right directions. As a result, the same operational feeling is imparted to the tilt operation on the rod 34 in the R position as at the time of the tilt operation in the L position.

The following effects are obtained according to the above-described first embodiment. Two of the moving contacts 19, the combinations of which differ depending on in which of the up, down, left, and right directions the tilt operation is performed on the rod 34 when the rod 34 is in either the L position or the R position, are operated to move from the off position to the on position by the upper plate 44 or the lower plate 45. As a result, a sliding contact is not necessary, and the operational feeling of the rod 34 is improved.

The LED 38 is arranged facing the front end surface of the rod 34, and the light emitted from the LED 38 is caused to exit through both the front end surface of the rod 34 and the rear end surface thereof. The rod 34 is thus efficiently illuminated by the light emitted from the LED 38.

The rotor 27 is supported from the front side by the inner body 21, which causes the inner body 21 to prevent the movement of the rotor 27 from the rear toward the front, the movement being caused by the operation force on the rod 34 when the tilt operation is performed on the rod 34 in either the L position or the R position. As a result, the rod 34 is prevented from moving from the rear toward the front, which prevents the moving contacts 19 that do not correspond to the tilt direction of the rod 34 from being mistakenly operated to move from the off position to the on position by the upper plate 44 or the lower plate 45.

The ten skirts 17 and the ten holders 18 are integrally formed as the contact rubber 16. Therefore, when the front door on the driver side has been opened, the ten moving contacts 10 and the ten sets of fixed contacts 20 do not become wet by rainwater, and waterproofness of the switch device is thus improved.

In the above-described first embodiment, the moving contacts 19 may be arranged such that three or more of the moving contacts 19, combinations of which differ depending on in which of the up, down, left, and right directions the tilt operation is performed on the rod 34 when the rod 34 is in either the L position or the R position, are operated to move from the off position to the on position by the upper plate 44 or the lower plate 45. In this case, wiring of the fixed contacts 20 with respect to the right LR motor 1 to the left UD motor 4 may be changed in accordance with the arrangement of the moving contacts 19.

In the above-described first embodiment, the present invention may be adopted to a switch device other than an outer mirror device of a vehicle. In this case, the rotation positions of the rod 34 may be changed to three or more in accordance with a target of application of the switch device, and the tilt directions in each of the rotation positions of the rod 34 may be changed to two, three, five or more, in accordance with the target of application.

### INDUSTRIAL APPLICABILITY

The present invention can be applied to a switch device provided with an operation member on which a tilt operation is performed in a plurality of directions, such as a switch device for operating a door mirror of a vehicle.

### REFERENCE SIGNS LIST

11 BODY
19 MOVING CONTACT (OPPOSITE CONTACT)
20 FIXED CONTACT
21 INNER BODY (SUPPORT MEMBER)
27 ROTOR (ROTATION MEMBER)
34 ROD (OPERATION MEMBER)
38 LED (LIGHT SOURCE)
44 UPPER PLATE (SWITCH OPERATION PART)
45 LOWER PLATE (SWITCH OPERATION PART)

1. A switch device, comprising:
an operation member configured to be rotationally operated to a plurality of effective rotation positions around an axis, a tilt operation being performed on the operation member in a plurality of directions that are common to each of the plurality of rotation positions;
a plurality of switch operation parts provided on the operation member, the switch operation parts being displaced from each other in a circumferential direction around the axis of the operation member;
a plurality of opposite contacts each capable of moving between an off position and an on position; and
a plurality of fixed contacts provided for each of the plurality of opposite contacts, the fixed contacts facing the respective opposite contacts via a gap when the opposite contacts are in the off position and being in contact with the respective opposite contacts when the opposite contacts are in the on position,
wherein the plurality of opposite contacts are arranged such that at least two of the opposite contacts, combinations of which differ depending on in which of the plurality of directions the tilt operation is performed on the operation member in which of the plurality of rotation positions, are operated to move from the off position to the on position by one of the plurality of switch operation parts.

2. The switch device according to claim 1, further comprising a light source arranged facing one end surface in an axial direction of the operation member and configured to emit light toward the one end surface of the operation member,
wherein the operation member has translucency so as to allow the light emitted from the light source to exit from an other end surface of the operation member in the axial direction.

3. The switch device according to claim 1, further comprising:
a body housing the plurality of opposite contacts and the plurality of fixed contacts;
a rotation member rotatably housed inside the body, the rotation member being coupled to the operation member such that the operation member is capable of tilting and such that the operation member is capable of rotating integrally with the rotation member; and
a support member housed inside the body, the support member being incapable of moving with respect to a movement direction of the plurality of opposite contacts from the off position to the on position,
wherein the support member supports the rotation member in a direction opposite to the movement direction of the plurality of opposite contacts from the off position to the on position.
